(19) United States
(12) Patent Application Publication
(10) Pub. No.: US 2006/0031812 A1
(43) Pub. Date: Feb. 9, 2006

(54) System and method for checklist management

(76) Inventors: Karl Olson, Fort Collins, CO (US); Paul Greathouse, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/911,839

(22) Filed: Aug. 3, 2004

(51) Int. Cl. G06F 9/44

(52) U.S. Cl. 717/101

(57) ABSTRACT

A system and method is provided for managing checklists in a software development project. The system includes a question editing module, a template editing module, and a checklist editing module. The question editing module is configured to create and edit control questions with a database. The template editing module enables the creation and editing of templates within the database. Editing a template creates a new copy of the template with an updated version number in the database and the existing template is maintained unchanged. The checklist management module creates checklists within the database. Checklists include template references to a template of a particular version number and user answers to the control questions referenced by the template.

### FIELD OF THE INVENTION

The present invention relates generally to managing checklists related to software development.

### BACKGROUND

A component of most software development processes is software quality management. Management of software quality often includes the dissemination and filling out of various checklists during the development process. For example, checklists can consist of a series of questions that ensure a developer has considered various aspects related to the reliability, functionality and quality of the software being developed.

Traditionally, software quality management checklists have been assembled using a word processor and then edited and distributed manually. Filling out checklists is also a largely manual process, sometimes requiring a software developer to repeatedly fill in forms with the same data. Maintaining paper copies of these checklists is tedious, since paper copies are not readily accessible to team members and may become lost or misfiled. Electronic copies, although more convenient, may not have adequate controls to ensure that the correct checklists are used and maintained. Checklists can also become lost or misfiled in an electronic directory system.

Many different checklists may be required within a software development project. For example, change request checklists may include a variety of questions concerning a reported bug or requested feature addition. Patch checklists may include questions concerning whether requested software fixes or changes have been developed and tested. Different checklists with varying questions may be required for developers and testers. Although similar checklists may be used for many projects, changes may be required to accommodate unique project requirements or changes in the software development process. Changes to checklists can be difficult to manage, as documents may be stored on many different users' hard disk drives or network storage locations. Managing these changes can also be difficult when many users have partially completed checklists.

### SUMMARY OF THE INVENTION

The invention includes a system for managing checklists in a software development project. The system includes a question editing module, a template editing module, and a checklist editing module. The question editing module is configured to create and edit control questions with a database. The template editing module enables the creation and editing of templates within the database. Editing a template creates a new copy of the template with an updated version number in the database and the existing template is maintained unchanged. The checklist management module creates checklists within the database. Checklists include template references to a template of a particular version number and user answers to the control questions referenced by the template.

### BRIEF DESCRIPTION OF THE DRAWINGS

FIG. 1 is a block diagram of a system for managing checklists for a software development project, in accordance with an embodiment of the present invention;

FIG. 2 is a block diagram of a database arrangement in accordance with an embodiment of the present invention;

FIG. 3 is a block diagram of checklists having template references to templates, in accordance with an embodiment of the present invention;

FIG. 4 is a block diagram of a patch checklist having references to a plurality of change request checklists, in accordance with an embodiment of the present invention;

FIG. 5 is a block diagram of a system for managing checklists for a software development project using a cloning module, in accordance with an embodiment of the present invention;

FIG. 6 is a block diagram of a new checklist created by cloning an existing checklist, in accordance with an embodiment of the present invention; and

FIG. 7 is flowchart of a method for managing electronic quality control checklists, in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

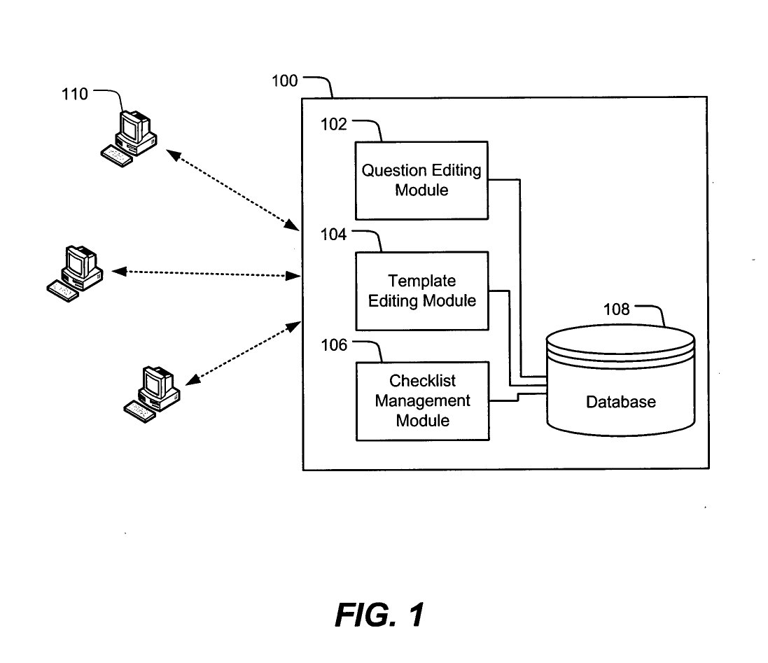

As illustrated in FIG. 1, a system for managing checklists for a software development project is shown in accordance with an embodiment of the present invention. The system 100 may be accessed by one or more users 110 (e.g., through the use of a web browser, stand alone application, or electronic access). Various implementation techniques will occur to one of skill in the art. For example, the system may be implemented as a web-based application enabled by a back-end relational database, such as a set of Perl CGI Scripts running on an Apache web server to access an Oracle® database.

The system may include a question editing module 102, a template editing module 104, and a checklist management module 106. For example, the question editing module allows end users to create and edit control questions within a database 108. The template editing module enables the user creation and editing of templates within the database. Templates can include references to one or more control questions. For example, a template can define a quality control survey, and the control questions may be a series of pre-defined text questions related to a particular software development project. The questions may also be checkboxes, radio buttons, text areas, selection pull-downs, audio clips, video, known HTML (Hypertext Markup Language) form elements, or other question formats that can be generated by an electronic system and answered by an end user.

The checklist management module 106 permits a user to create a checklist within the database. A checklist includes a template reference to a template of a particular version number and contains user answers to the control questions referenced by the template. Generally, a checklist will reference a single template. For example, to fill out a quality control survey, a user may create a new checklist, specifying the template (and hence the list of control questions) to be used. Additional details of the operation of the question editing module, template editing module, and checklist management module will become clear from the discussion below.

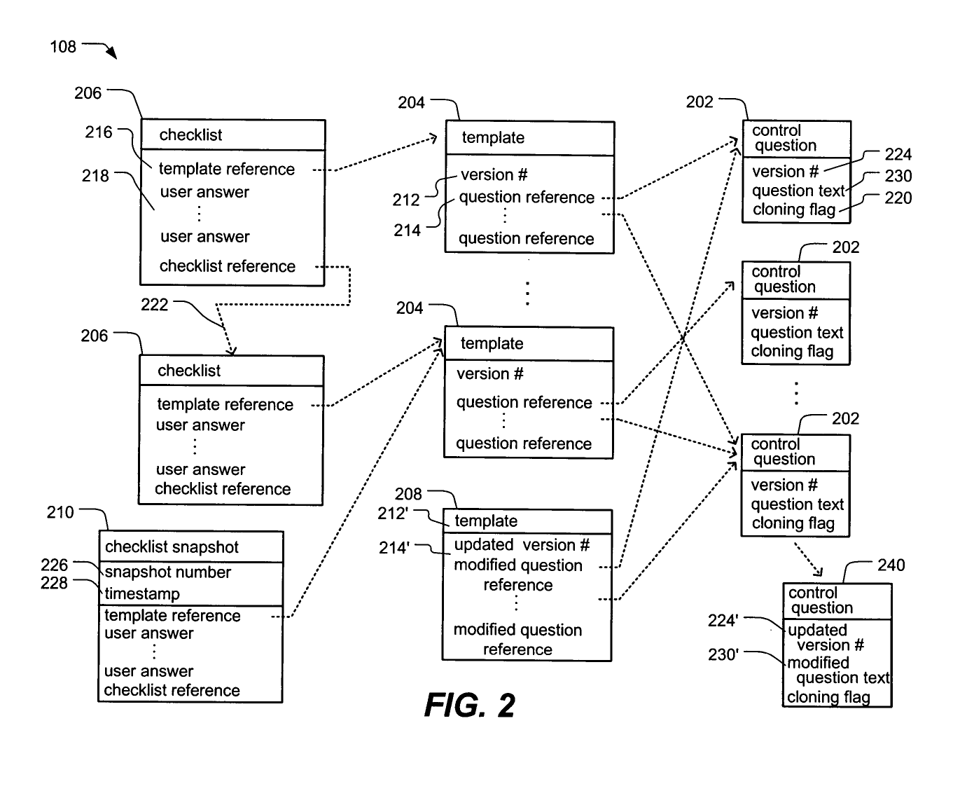

The database 108 may be configured to store control questions 202, templates 204, and checklists 206, as illustrated in FIG. 2, in accordance with an embodiment of the present invention. Each template may include a template version number 212 and references 214 to control questions. Multiple templates may reference the same control question. The control questions may include question text 230. The checklist includes a reference 216 to a template 204 and user answers 218 to the control questions referenced by the template. The template reference is to a template of a particular version number.

Multiple versions of templates can be maintained. When an existing template is edited 204, a new, modified copy of the template 208 is created in the database. The new, modified copy of the template has an updated version number 212′ and can include modified references 214′ to the control questions 202. The existing template is maintained unchanged. Hence, checklists are substantially unaffected when existing templates are edited, since the checklists' template references 216 to the existing template retain their validity.

Several benefits to users of the system are provided by maintaining previous versions of templates and using references to templates of particular versions in the checklists. First, templates can be edited after a checklist is created without disrupting an existing checklist. New or modified templates can therefore be rolled out without inconveniencing users who have begun to complete a checklist. Users who have already begun to complete checklists can continue to fill out the checklist created using the previous version of the template.

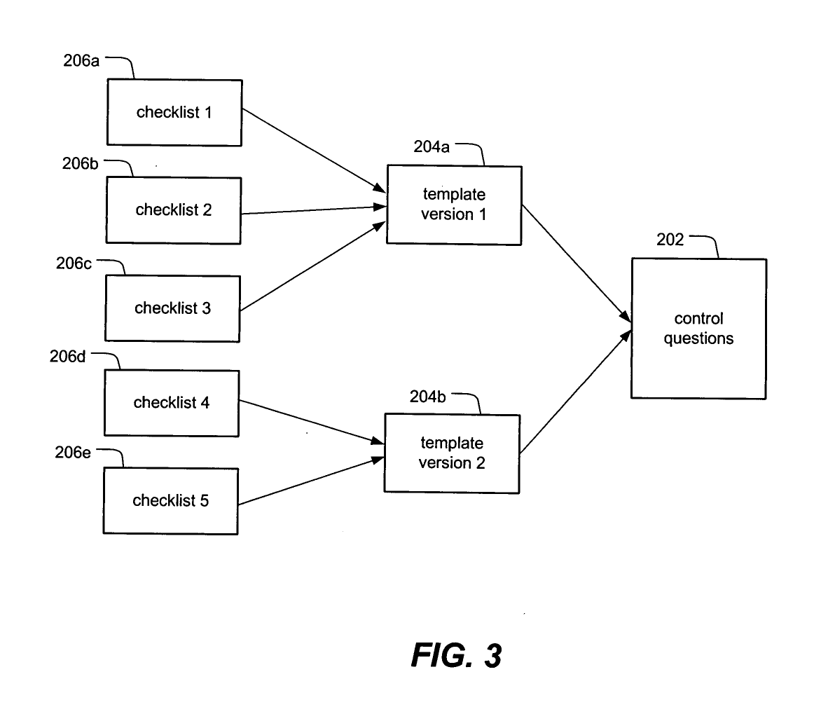

For example, FIG. 3 illustrates an embodiment of several checklists and template versions. The checklists 206a, 206b, 206c, 206d, 206e reference the same template, although they are created at different times and thus reference different versions of the template 204a and 204b. Initially, the first three checklists 206a, 206b, 206c are created and reference the initial version (version 1) of the template 204a. After the first three checklists are created, the template is edited, creating a new version (version 2) of the template 204b. Later created checklists 206d and 206e reference the latest version of the template 204b. The use of the term “latest version” of the template in this description can also be interpreted to mean the “most recently created version” of the template. The earlier created checklists 206a, 206b, 206c continue to reference the previous version of the template 204a. Hence, user answers to control questions retain their relationship to the template version under which they were originally created. This allows new template versions to be created while maintaining the original relationship of user answers to control questions in existing templates. A smooth migration to the newest template versions is also provided, since checklists created with previous versions of templates are not bound by the specifications of the new versions of templates.

An additional advantage of maintaining the previous versions of templates is associated with the saving of checklist snapshots. Checklist snapshots maintain an archive of the current state of user answers to a checklist, and are thus associated with the particular version of the template used to create the checklist. Referring back to FIG. 2, a checklist snapshot 210 may be created by copying the template reference 216 and user answers 218 of a checklist 206 to the checklist snapshot 210, and assigning a unique snapshot number 226. For example, the first time a snapshot is taken, the snapshot number may be set to one. The next time, the snapshot number is two, etc. In this way, a virtually unlimited number of checklist snapshots may be maintained. Optionally, checklists can be stored in the same data area or data structure as checklist snapshots, and snapshot zero defined as the current checklist.

The checklist snapshot may also include a time stamp 228. Optionally, snapshot creation may be automated in order to automatically store snapshots of all checklists at pre-defined time or work intervals.

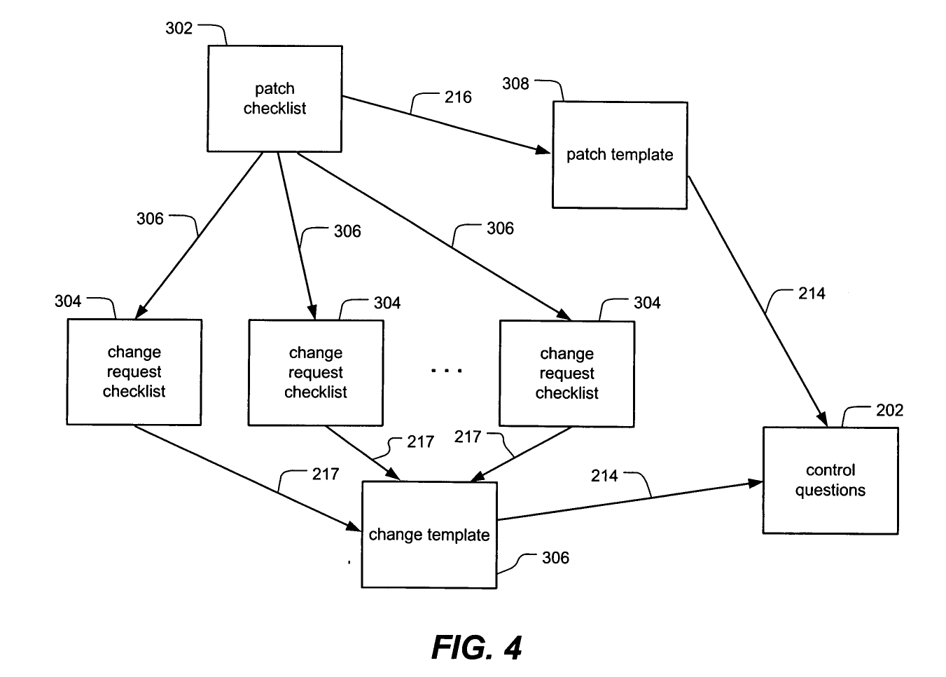

Another feature provided by embodiments of the present invention is the maintaining of multiple types of checklists, which may use references to other checklists. For example, a software development project may require both change request checklists and patch checklists as illustrated in FIG. 4, in accordance with an embodiment of the present invention. Change request checklists 304 can define a change requested in the next (or future) release of the software. A patch checklist 302 may define a software release and include references 306 to a number of change request checklists 304. Hence, many change requests can be grouped together into a single software patch. The patch checklist can include none, one, or virtually any number of references to change request checklists. The patch checklist can also include a template reference 216 to a patch template 308. For example, a patch template can reference 214 control questions 202 regarding the development and testing of a patch. The change request checklist 304 may include a template reference 217 to a change template 306. As an example, a change template can reference control questions 202 regarding a defect found or feature requested. Various techniques for designating a checklist type will occur to one of skill in the art. Accordingly, a field may be included in the checklist which indicates the checklist type.

Referring again to FIG. 1, the checklist management module 106 may generate a display window and/or screen that shows the relevant checklist data on a summary screen and this allows the user to view, add, or delete associations between patch checklists and change request checklists. By providing the references between the checklists, the process of locating all related checklists for a software release may be simplified. Grouping multiple change requests into a single software patch can provide greater efficiency in the software development and quality management processes. For example, by associating a single patch checklist with multiple change requests, certain control questions defined in the patch checklist can be answered once, rather than repeatedly for each change request. Furthermore, software quality assurance requirements that require completed checklists for all related change requests may be electronically enforced.

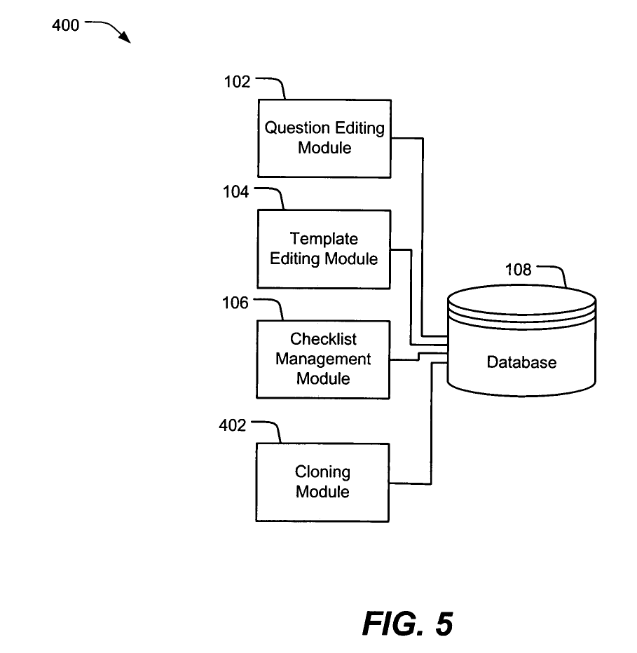

Another feature provided in one embodiment of the present invention is the easy creation of new checklists. FIG. 5 illustrates a system 400 for managing checklists related to software development, in accordance with an embodiment of the present invention. The system may include a question editing module 102, a template editing module 104, and a checklist management module 106 interacting with a database 108 as described above. The system may also include a cloning module 402. The cloning module is configured to copy user answers corresponding to control questions for which the cloning flag is set.

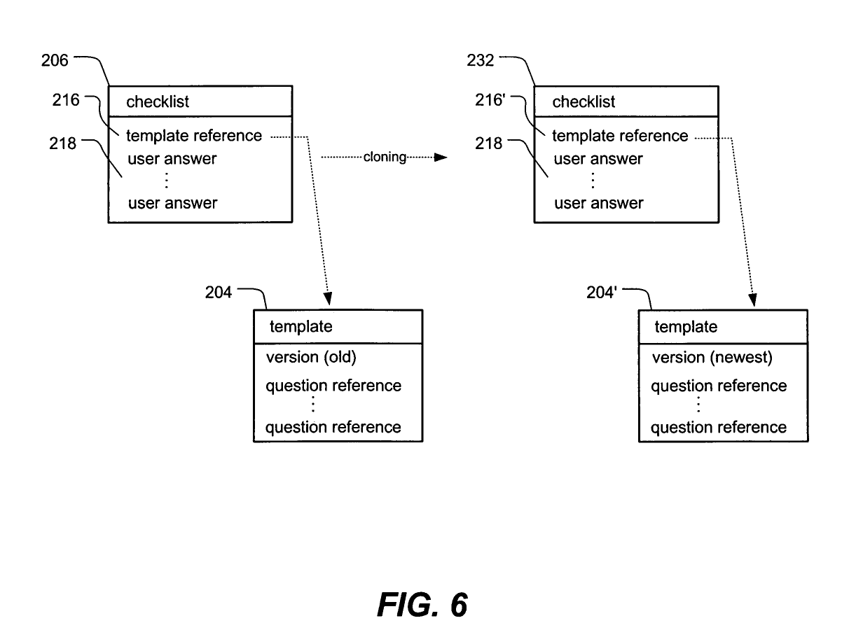

For example, referring to FIG. 6, cloning an existing checklist 206 may be accomplished by creating a new checklist 232. The new checklist template reference 216′ is set to refer to the latest version 204′ of the template 204 referenced by the existing checklist. In addition, the plurality of user answers 218 to the control questions are copied from the existing checklist into the new checklist. Of course, only user answers to control questions that are common to the latest and previous versions of the template need be copied.

Alternately, cloning may be implemented by the checklist management module. For example, cloning may be activated by a link button on a checklist display screen. Cloning can be valuable to users who fill out checklists on a regular basis with little variation in their responses. By permitting the copying of user answers, the user may avoid needing to reenter all of his answers into the new checklist.

The operation of cloning can be enhanced by including a cloning flag 220 (FIG. 2) with each control question 202 to enable and disable the copying of a user answer corresponding to that control question. Individual questions can then be labeled as non-cloneable to prevent the copying of user answers that are only relevant to the previous checklist or to force users to re-enter comparatively important answers. For example, a control question that asks for the name of the programmer may be labeled as cloneable, but a control question that asks whether a particular quality check has been performed may be labeled as non-cloneable.

Another feature provided is the optional inclusion of versioning for the control questions. Each control question 202 may include a version number 224. The editing of a control question causes a new, modified copy 240 of the control question to be created with an updated version number 224′ and modified question text 230′. Hence, template references to the control questions are maintained unchanged. For example, a minor change may be made to a question which does not alter the response solicited, but involves things like typo corrections or re-wording. Creating a new question is undesirable, because it would require updating templates to reference the new question and affect the operation of cloning as discussed below. By creating a new version of the question, template references retain their validity. When a new checklist is created, the latest versions of the control questions may be used.

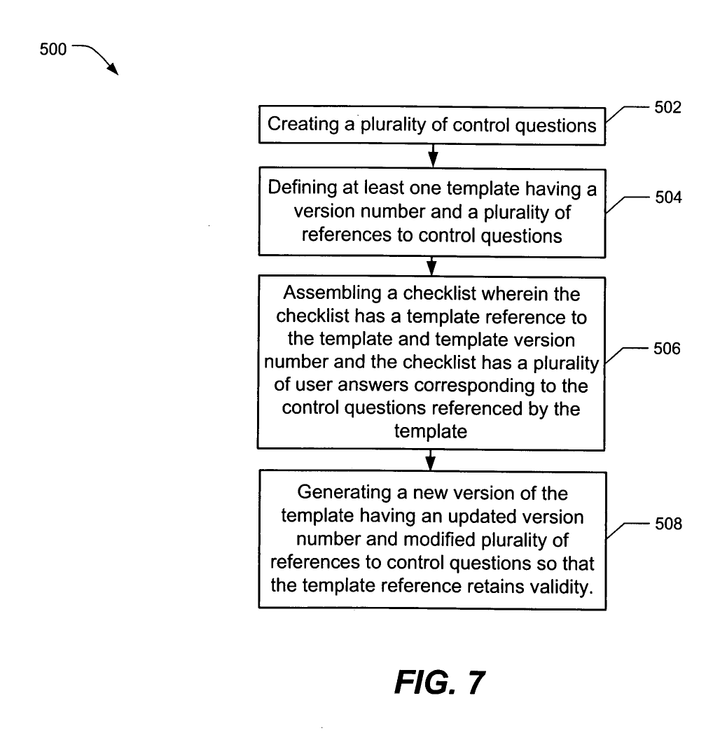

A flowchart of a method for managing electronic quality control checklists is illustrated in FIG. 7, in accordance with another embodiment of the present invention. A first operation of the method is creating a plurality of control questions 502. For example, as discussed above, the control questions may be stored in a database. A second operation for the method is defining at least one template having a version number and a plurality of references to control questions 504. As discussed previously, the template can be stored in the database and define a set of questions to be answered by a user. The questions are defined by references to the control questions.

The method may also include assembling a checklist 506. An assembled checklist includes a template reference to the template, and user answers corresponding to the control questions referenced by the template. The checklist may be stored in the database. Multiple checklists can be created, referencing the same or different templates. Similarly, multiple templates can be created, referencing the same or different questions.

Finally, the method may include generating a new version of the template 508. The new version has an updated version number and modified references to control questions. Hence, the template reference of the previously created checklist retains validity. For example, refer to FIG. 3 and the discussion above.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. A system for managing checklists related to software development, comprising:
a question editing module configured to create and edit control questions within a database;
a template editing module configured to create and edit templates within the database, the templates each having a version number and a plurality of references to control questions, wherein editing an existing template creates a new template in the database with an updated version number and the existing template is maintained unchanged; and
a checklist management module configured to create checklists within the database, wherein the checklist includes a template reference to a template of a particular version number and a plurality of user answers to the control questions referenced by the template.

2. The system of claim 1, wherein the question editing module is further configured so that editing an existing control question causes a new copy of the control question with an updated version number to be created in the database and the existing control question to be maintained unchanged.

3. The system of claim 1, wherein the checklist is capable of including at least one reference to another checklist.

4. The system of claim 1, wherein the checklist management module is further configured to clone checklists, wherein a cloned checklist includes the template reference to the latest version of the template referenced by a checklist being cloned and the plurality of user answers copied from the checklist being cloned.

5. The system of claim 4, wherein the control questions each include a cloning flag and a cloning module is further configured to copy user answers corresponding to control questions for which the cloning flag is set.

6. A system for managing electronic quality control checklists for software development, comprising:
a database having a plurality of control questions;
a plurality of templates stored in the database, each template having a version number and a plurality of references to the control questions, wherein editing an existing template creates a new modified template in the database with an updated version number and the existing template is maintained unchanged; and
a checklist stored in the database, the checklist having a template reference to a template of a particular version number and a plurality of user answers to the control questions referenced by the template so that the checklist is substantially unaffected by editing an existing template.

7. The system of claim 6, wherein each control question has a version number, and wherein editing an existing control question creates a new modified copy of the control question with an updated version number and maintains the existing control question unchanged.

8. The system of claim 6, wherein the checklist is capable of including at least one reference to another checklist.

9. The system of claim 6, further comprising:
a plurality of change request checklists, each having a change template reference to a change template and a plurality of user answers to control questions referenced by the change template.

10. The system of claim 9, further comprising a plurality of patch checklists, each having a patch template reference to a patch template and a plurality of user answers to control questions referenced by the patch template, wherein patch checklists are each capable of including at least one reference to change request checklist.

11. The system of claim 6, wherein the checklist is created by taking a latest version of the template referenced by an existing checklist and copying the plurality of user answers to the referenced control questions from the existing checklist into the new checklist.

12. The system of claim 11, wherein each control question has a cloning flag to enable and disable copying a user answer corresponding to that control question.

13. The system of claim 6, further comprising a checklist snapshot wherein the checklist snapshot is created by copying the template reference and the user answers of the checklist and assigning a snapshot number to enable a plurality of checklist snapshots may be maintained.

14. A method for managing electronic quality control checklists, comprising:
creating a plurality of control questions;
defining at least one template having a template version number and a plurality of references to control questions;
assembling a checklist having a template reference to the template and the template version number, wherein the checklist has a plurality of user answers corresponding to the control questions referenced by the template; and
generating a new version of the template having an updated version number and modified plurality of references to control questions so that the template reference for a previously generated checklist retains validity.

15. The method of claim 14 further comprising designating the checklist as either a patch checklist or a change request checklist, wherein the patch checklist is capable of including at least one reference to the change request checklist.

16. The method of claim 14 wherein assembling a checklist further comprises including in the checklist at least one reference to another checklist.

17. The method of claim 14 wherein assembling a checklist further comprises setting the template reference to a most recent version of the template existing at the time the checklist is created.

18. The method of claim 14 wherein creating a plurality of control questions further comprises assigning each control question a version number and a question text.

19. The method of claim 18 wherein defining at least one template further comprises setting the plurality of references to control questions to a particular version number of control questions.

20. The method of claim 19 wherein defining a template further comprises setting the plurality of references to control questions to reference latest versions of the control questions at the time the template is defined.

21. The method of claim 18 wherein the plurality of user answers corresponds to latest versions of the control questions at the time the checklist is created.

22. The method of claim 18 further comprising creating a new control question from an existing control question, the new control question including an updated version number and a modified copy of the question text of the existing control question, wherein the existing control question is left unchanged.

23. The method of claim 14 further comprising:
creating a new checklist having the template reference to a most recent version of the template referenced by an existing checklist; and
copying user answers from the existing checklist into the new checklist for control questions in the new checklist having corresponding answers in the existing checklist.

24. The method of claim 23 wherein copying user answers further comprises copying a user answer from the existing checklist into the new checklist when a cloning flag associated with the corresponding control question is set to allow copying.

25. The method of claim 14 further comprising:
copying the user answers from an existing checklist into a checklist snapshot; and
assigning a unique snapshot number to the checklist snapshot, whereby a plurality of checklist snapshots are maintained.

26. The method of claim 14 further comprising creating a plurality of templates each having a version number and a plurality of references to control questions, wherein the plurality of templates may each reference the same control questions.

27. An article of manufacture, comprising:
a computer usable medium having computer readable program code embodied therein for managing electronic quality control checklists, the computer readable program code in the article of manufacture comprising:
computer readable program code configured to create a plurality of control questions;
computer readable program code configured to define at least one template having a template version number and a plurality of references to control questions;
computer readable program code configured to assemble a checklist having a template reference to the template and the template version number, wherein the checklist has a plurality of user answers corresponding to the control questions referenced by the template;
computer readable program code configured to assemble a checklist having a template reference to the template and the template version number, wherein the checklist has a plurality of user answers corresponding to the control questions referenced by the template; and
computer readable program code configured to generate a new version of the template having an updated version number and modified plurality of references to control questions so that the template reference for the previously generated checklist retains validity.

28. A system for managing electronic software quality management checklists, comprising:
a question editing means for creating control questions stored in a database;
a template editing means for defining templates having a version number and a plurality of references to the control questions;
a checklist creation means for generating checklists having a template reference to a template of a particular version number and having user answers to the control questions referenced by the template; and
a checklist editing means for editing templates so that the template reference of a checklist retains validity.
